(19) United States
(12) Patent Application Publication
(10) Pub. No.: US 2008/0177734 A1
(43) Pub. Date: Jul. 24, 2008

(54) Method for Presenting Result Sets for Probabilistic Queries

(76) Inventors: Derek L. Schwenke, Marlboro, MA (US); Kent B. Wittenburg, Lynnfield, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/057,668

(22) Filed: Mar. 28, 2008

Related U.S. Application Data
(63) Continuation-in-part of application No. 11/353,289, filed on Feb. 10, 2006.

(51) Int. Cl. G06F 17/30

(52) U.S. Cl. 707/5; 707/E17.014

(57) ABSTRACT

A method presents a rank-ordered result set for a probabilistic input query. Terms in the query are recognized and a probability is assigned to each term. The probability expresses a confidence in correctly recognizing the term. A database is searched for items corresponding to the probabilistic query using the terms and the assigned probabilities to produce a result set. The result set is then highlighted according to the probabilities and presented to a user as a hierarchical graph, where a level in the hierarchy represents an ordering ranking of the result set.

### RELATED APPLICATION

This is a Continuation-in-Part application of U.S. patent application Ser. No. 11/353,289, “Method for presenting result sets for probabilistic queries,” filed on Feb. 10, 2006.

### FIELD OF THE INVENTION

The invention relates generally to searching databases and presenting result sets, and more particularly to searching and presenting rank ordered result sets with ambiguous or probabilistic queries.

### BACKGROUND OF THE INVENTION

The amount of searchable content that is produced and distributed world-wide is increasing at an enormous rate on a day to day basis. Content can be in the form of web pages, images, videos, music, and the like. Content is readily available from a number of sources, including broadcasters, cable and satellite distributors, wireless providers, and the Internet. As the amount of content increases, the problem of searching for desired content is increasing likewise.

Internet distribution channels can stream or download content directly to television systems, digital video recorders (DVRs), personal computers (PCs), and mobile devices such as cellular telephones, laptops and personal digital assistants (PDAs). PC-based browsers provide a reasonable interface for searching for content via text entry using keyboards. However, there is no satisfactory solution for searching for content using devices that do not include an alpha-numeric keyboard.

For example, a typical remote control used with televisions and other playback devices only includes a numeric keypad, cursor positioning keys, and other keys that control the various operating modes of the system that is being controlled. Most remote controls lack both pointer (mouse-like) functions, and alphanumeric keys. Option selection is done only by cursor controlled menus; text entry is extremely difficult, awkward, and time consuming. Searching for a program, when several weeks of advance programming are available for over a hundred channels on an electronic program guide (EPG), can be frustrating. In essence, a typical remote control device is useless as a text input device. The same problem exists for most small, hand-held mobile devices.

One solution is to provide a speech interface for a query interface. One interface uses speech to specify a limited set of commands, see A. Ibrahim, J. Lundberg and J. Johansson, “Speech Enhanced Remote Control for Media Terminal,” Proceedings of Eurospeech'01, Volume 4, pp. 2685-2688, 2001; and Promptu, available from AgileTV Menlo Park, Calif., USA. The Promptu remote control includes a talk button and a microphone. The remote control interfaces with a set top box to scan and find on-demand video content using predetermined speech input commands. The other interface is dialog-based, see P. Johansson, “MADFILM—A Multimodal Approach to Handle Search and Organization in a Movie Recommendation System,” Proceedings of the 1st Nordic Symposium on Multimodal Communication, pp. 53-65, Sep. 25-26, 2003; and W. Wahlster, “SmartKom: Symmetric Multimodality in an Adaptive and Reusable Dialogue Shell,” Proceedings of the Human Computer Interaction Status Conference 2003, pp. 47-62, June 2003.

A problem with the first type of interface is that the user must first learn the commands that operate the system, and error correction may be required, Berglund et al., “Error Resolution Strategies for Interactive Television Speech Interfaces,” Human-Computer Interaction, Interact 2003, pp. 105-112, 2003. The second type of interface increases the cost and complexity of design and development. Also, it is not clear that a conversational style speech interface is suitable for interaction with a television system using a remote control, where an instant response is demanded by the user.

Another interface uses a speech-in, list-out paradigm, Divi et al., “A Speech-In List-Out Approach to Spoken User Interfaces,” Human Language Technology Conference, May 2004. That interface is based on SpokenQuery technology described by Wolf et al., “The MERL SpokenQuery Information Retrieval System: A System for Retrieving Pertinent Documents from a Spoken Query,” IEEE International Conference on Multimedia and Expo (ICME), Vol. 2, pp. 317-320, August 2002; Wolf et al., “SpokenQuery: An Alternate Approach to Choosing Items with Speech,” International Conference on Speech and Language Processing (ICSLP), ICSLP 2004, October 2004; and U.S. Pat. No. 6,877,001, “Retrieving Documents with Spoken Queries,” Wolf et al., granted Apr. 5, 2005 and incorporated herein by reference.

There, an output of a speech recognition engine is not used as a full specification of a text query, but rather as a set of tokens that can be matched with items in a database. Conceptually, this interface is similar to a textual query interface. However, a significant difference is that the recognized words in the query have a probabilistic uncertainty. That is, the speech recognizer is not perfect; similar sounding textual words are often incorrectly recognized spoken words. At best, the recognizer can only assign a confidence score.

Often, the user is faced with the problem of determining whether a requested item does not exist in a particular database or whether the spoken query was misinterpreted.

Most search engines, such as Google™, AltaVista™, and Yahoo™ use extremely sophisticated techniques to rank order a result set of items that is produced in response to a query. The rank order attempts to take into account the degree of relevance of the items found. The relevance can be based on the frequency and location of occurrences of the key words, the way the item is linked to other similar items, or perhaps, the amount of advertising dollars spent.

### SUMMARY OF THE INVENTION

The invention provides a method for searching a database of items using a probabilistic query as input. The query is composed of terms, for example, representations of the spoken words or phrases said by the user. Each term has an associated probability that the term was what the user intended. The data base is searched using these terms and their associated probabilities that the term matched what the user intended to produce a rank-ordered result set of items. Each item is associated with a description that includes the terms used to justify the inclusion and rank of the item, along with a probability that the term was what the user intended.

The descriptions are presented to the user as a rank-ordered result set with annotated terms and highlighting. The highlighting of the result set is in accordance with the associated probabilities. The highlighting can include the rank ordering in which the items are presented, as well as the visual appearance of the descriptions, e.g., the size, color, emphasis, or font of the letters and words. The appearance effects can be spatial, as well as temporal. For example, the words can move or blink. The highlighting can also be conveyed acoustically.

It should be noted that the highlighting is not based on search relevance scores as in prior art search engines, but rather on confidence scores of the interpretation of the query by some recognition engine.

The highlighting provides the user with feedback on how the query was interpreted and applied during the searching of the database. It should be noted that uncertainty can also be introduce into the recognized query before the database is searched.

In one embodiment, the result set is presented as a hierarchical graph, with the hierarchy is determined by the ranking of the result set. A histogram corresponding to the result set can also be presented. The histogram as well as the hierarchical graph can by thresholded by a ‘strength” slider.

### BRIEF DESCRIPTION OF THE DRAWINGS

FIG. 1 is a flow diagram of a method for presenting a result set in response to a probabilistic query according to an embodiment of the invention;

FIG. 2 is a schematic of the results of a search for “china” in a fully expanded hierarchical graph;

FIG. 3 is a schematic of propagated highlight in the hierarchical graph;

FIG. 4 is a schematic of a hierarchical graph with hidden or collapsed results;

FIG. 5 is a schematic of a fully collapsed hierarchical graph;

FIG. 6 is a schematic of a hierarchical graph for an ambiguous query;

FIG. 7 is a histogram and visibility threshold slider for the hierarchical graph;

FIG. 8 is a schematic for a geographical map with a collapsible hierarchy; and

FIG. 9 is a schematic of a result set for a geographical map.

### DETAILED DESCRIPTION OF THE PREFERRED EMBODIMENT

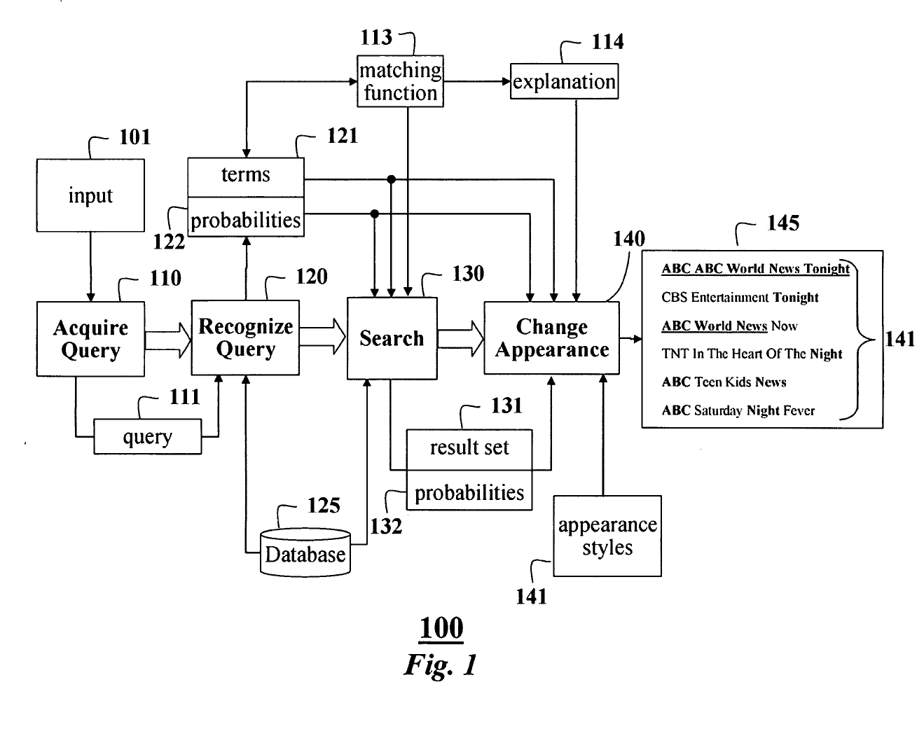

FIG. 1 shows a method 100 for presenting a result set of items in response to a probabilistic query according to an embodiment of the invention. Input 101 to the method 100 is a probabilistic query.

As defined herein, a probabilistic query has a degree of uncertainty associated with the interpretation of the meaning of the query. A typical probabilistic query is a spoken query. Other examples of probabilistic queries include an image or a ‘snippet’ of music.

The uncertainty in the query can be due to any combination of sources. For speech these include unclear pronunciation, environmental noises, microphone problems, etc. The recognition process itself and the speech models being matched add uncertainty. Dialectic variation in different languages increases the uncertainty about the meaning of the query.

In the case of images, there is uncertainty about the value of each pixel sampled. Lighting and shadows, and optical effects can obscure an image. Objects in images may be difficult to recognize. An image recognizer attempts to extract terms, e.g., image features such as shape, color, and size, from the image and provide a probability that each term occurs in the input image. However, complete certainty is not always possible.

It is an object of the invention to present results produced by a search engine in a way that takes into consideration these uncertainties, or a degree of confidence in the recognition process.

A query 111 is acquired 110, e.g., by a microphone or camera. The query is recognized 120 and interpreted as sets of possible terms 121. A probability 122 is assigned to each term. The recognition 120 can be performed by an automated speech recognizer, or computer vision object recognizer that has access to a database 125 that assists in the interpretation. The database can also include items to be searched 130 to generate a result set 131. The items can be web pages, images, documents, music files, and the like. Typically, the items in the result set are associated with short descriptions. The short descriptions can be generated ‘on the fly’ as the result set is produced. Typically, only the short descriptions are displayed or printed along with links to the actual items themselves, and the user can then select an item for full display.

Thus, the searching 130 of the database 125 produces the result set 131 matching the query. Associated with the result set are probabilities 132 that are based on or include the probabilities 122 of recognition combined with probabilities that the terms we found were together in the database. The database results may include weights that alter the ranking order.

The result set is changed 140 to include highlighting in accordance with the probabilities 132. The term ‘highlighting’ can include visual as well as acoustic effects. Items 146 in the highlighted result set 145 are highlighted according to appearance styles 141 as described below.

Typically, ‘terms’ in the descriptions of the items in the result set match terms in the probabilistic query. Terms with higher confidence scores or probabilities are highlighted. The terms can be partial or full words, numbers, letters, alphanumeric characters, phrases, ‘thumbnail’ images, and the like. The highlighting appearance 141 can include intensity, font, size, color, blink rate, bolding, relief, shadowing, 3D effects such ‘raised’ text, underlining, distorting, contrast, focus, fog, marking up, circling, boxing and background effects, animations, etc.

The highlighting appearance can be Boolean, e.g., bold or normal font to represent that the term occurred in the item. The highlighting can show an order, e.g., font size, or brightness relating to the confidence. The appearance can show multiple orderings at once, e.g. brightness relating to confidence and size relating to weighting of the term during the search, and color relating to something else.

The highlighting can include acoustic signals. For example, if the result set is presented via telephony, then the highlighting can consider volume, tone, frequency, rate, sound effects, inserts, overlays, such as a ringing bell.

The highlighting of images can consider distortion, color, intensity, overlays, animation, and the like. Videos can be similarly highlighted.

It should be noted that other probabilistic queries can be in the form of hand writing. For example in hand writing recognition the input can be characterized as a collection of lines that form letters and terms each with a level of confidence. The letters form words with a level of confidence that are predicted to be found in a database. The database itself contains word sequences that define the possible transcripts. In the resulting possible transcriptions of the hand writing, highlights can be used to show where database entries, matched or deviated from the hand writing terms.

### Hierarchical Result Set

So far we have described highlighting a result set for a probabilistic query visually and acoustically. In the parent application, the output is a rank ordered result set, with the best match first. The highlighting there is based on a confidence score of having correctly matched the query.

We now extend the presentation of the result to be a marked graph where vertical and horizontal positions are undefined or selected to represent a different ordering of the result set, such as parent-child, and the highlight provides a novel order to the presentation of the result set.

The methods can be applied to speech recognition confidence scores, or to other probabilities of any ambiguous query.

Even when the query itself is fully determined, uncertainty or ambiguity can be introduced as a way to find near or related matches, which can be useful for the user. One technique achieves this by applying a matching function 113 while searching 130. First, the matching function checks for an exact match. Then, the matching function checks for partial matches. Subsequently, the function iteratively removes letters or terms from the probabilistic query and checks for more matches. This is repeated until the query is empty.

As the function progresses, it assigns a match probability order to each item matched in the database based on the number of changes the function has to make to achieve the first match, and the size of the change, which can be found using some scale, e.g., alphabetic, or other.

The purpose of the matching function is to rank every item with the probability of a match to the user's query. The matching function can also produces an explanation 114 of how the matching while searching is performed, i.e., what is matched and what changes were made by the matching function. This explanation is used to generate of the correct highlights in the presentation later. The matching function can even make use of tables of miss typed letters, miss spellings, miss understood words or alias tables e.g.,

### QTY

[symbol]

### QUANTITY

### COUNT

### NUMBER

### NUM.

Some matching functions can produce result sets of items with the identical match probability values to reduce processing time assuming that a more precise result set is not useful. These results can be useful with this invention, where the similar match values are presented with similar highlight strengths.

In one embodiment of the invention, we present the highlighted result set as a hierarchical graph. Matching portions of each element in the hierarchical graph are highlighted. The highlight can indicate a probability of a match with the query.

The highlight can also show which portion of the query matched, and which portion missed. The highlight can be inherited when applied to the hierarchy, or traverse adjacent sub-graphs so that a ‘strongest’ highlight is clearly shown.

Results in the graph can be hidden or shown using a probability threshold. The user can set this threshold via a slider on a display screen. This highlight strategy enhances the usefulness of the slider.

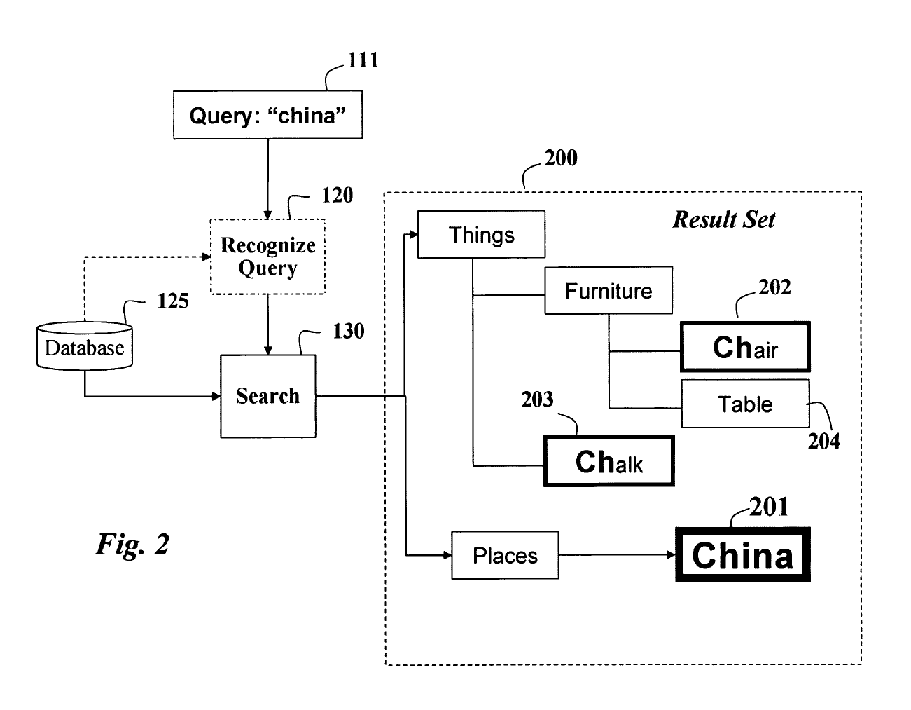

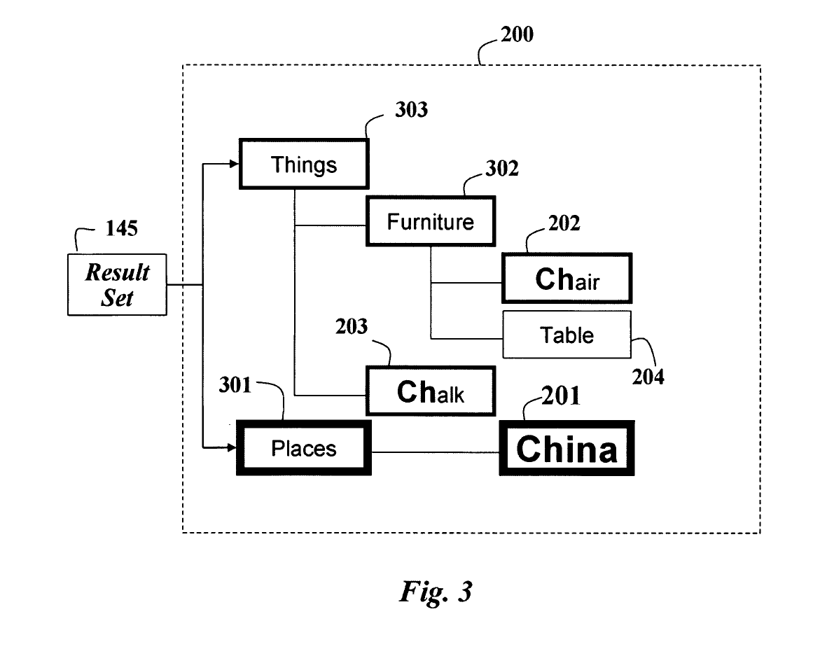

FIG. 2 shows an input query 111, “china” that is recognized 120 and used to search 130 the database 125. The result set is presented as a fully expanded hierarchical graph 200. The exact match 201, with a highest probability) is given the strongest highlight, the largest font, and largest outline in this example. The partial matches have weaker highlights that show which letters matched in this example, so the “ch” of “chair” 202, and the “ch” of “chalk” 203 are shown as weaker (lower probability) matches. The result “table” 204 has no highlight because it did not match the query in this example. This hierarchical graph is fully expanded and all results are visible. FIGS. 3-5 show details of how highlights traverse the hierarchy. FIG. 3 shows the same result set 200 for the query “china” as shown in FIG. 2. However, in this presentation the strongest highlight has been propagated up the hierarchy so that “place” 301 is now shown with a strongest highlight outline. Here, “thing” 302 and “furniture” 303 are shown with weaker highlights.

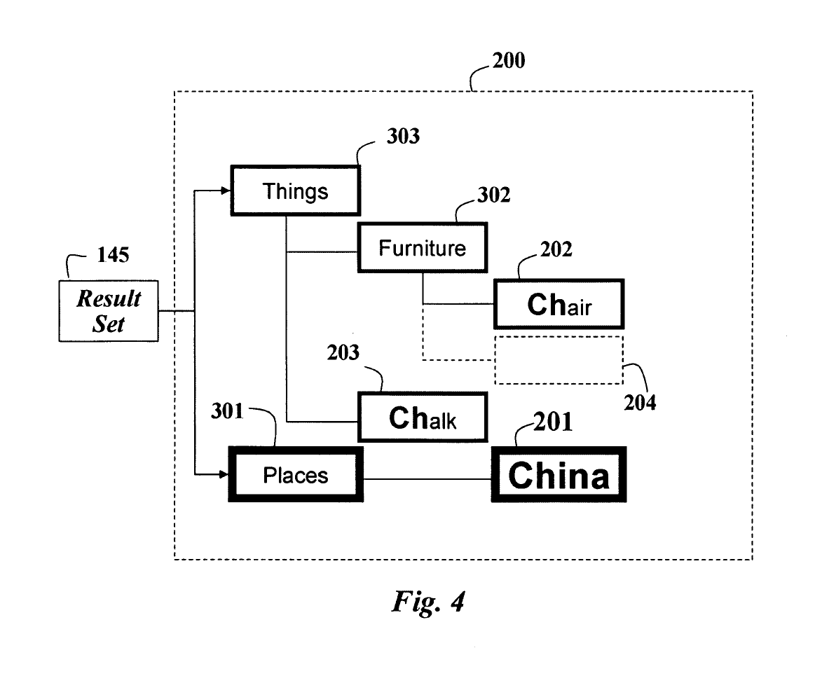

FIG. 4 shows the same result set 200 of a search for “china” as shown in FIG. 3. However in this presentation, the non matching result “table” 204 is hidden or collapsed from the hierarchy, as shown by dashed lines.

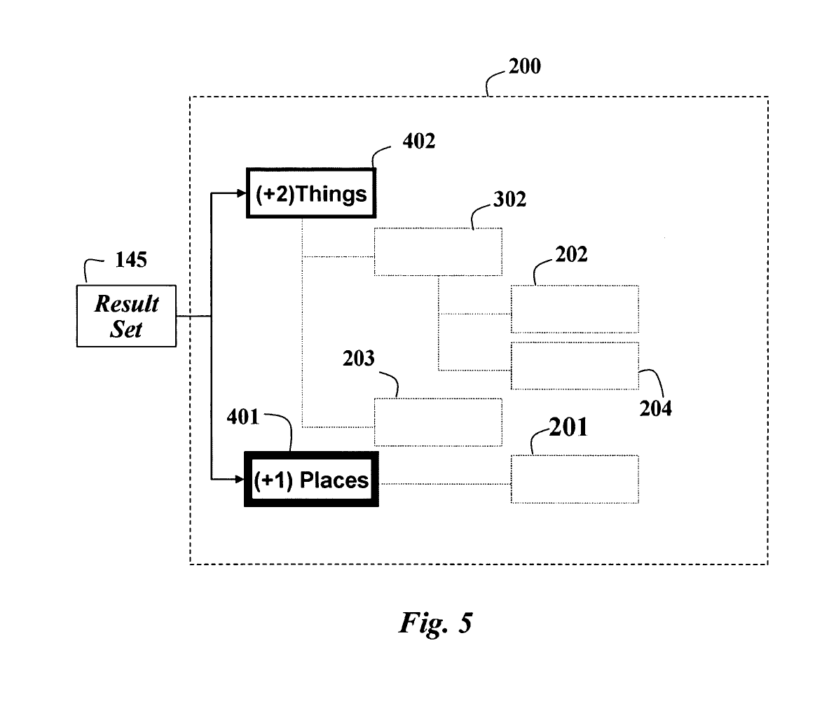

FIG. 5 shows the same result set 200. However in presentation the hierarchy has been fully collapsed and only the “root” nodes 401-402 are shown with the highlight traversing up the hierarchy, and a count of matches are shown. In this presentation, the user can still observe that one exact match was found for “place” 402, and two weak matches were found for “things” 402.

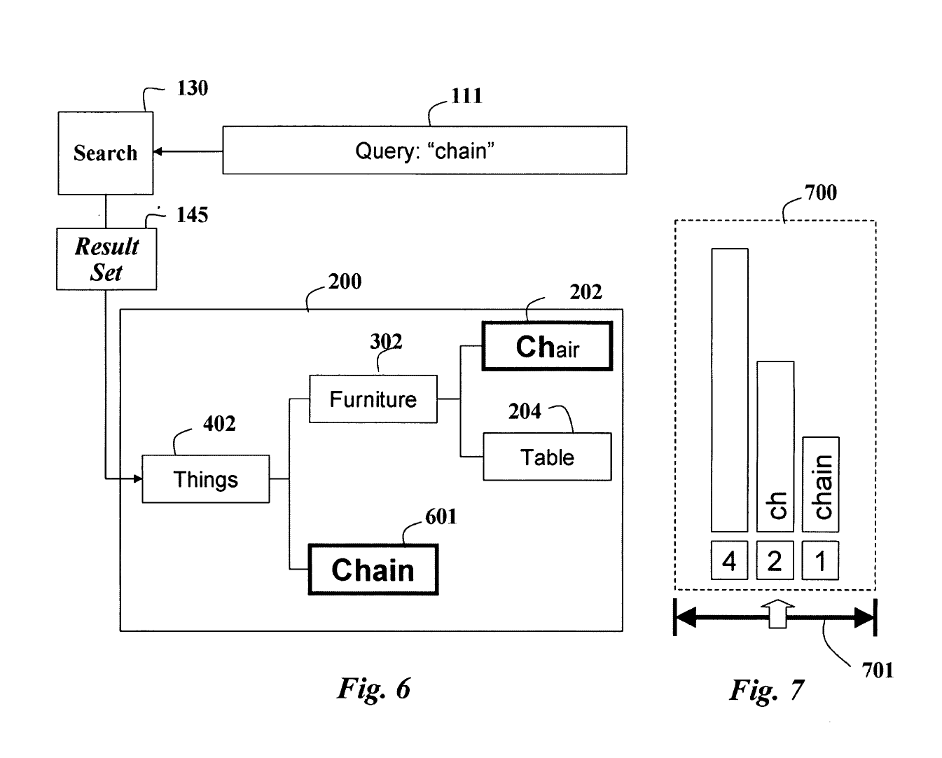

FIG. 6 shows the result set for a probabilistic search that has an ambiguous query. Therefore, the result set has a ranking of possible matches. When applied to the hierarchical graph 200, the result set form a graph where likely matches are partitioned into ordered sub-graphs of matches, and a depth of the graph indicates a relative ranking of the matches. In the graph, a visibility of the sub-graphs can be controlled by applying a probability threshold to the graph.

As shown in FIG. 7, a histogram 700 of search probabilities is also presented to the user as a guide to refine the search. This can be done by applying a threshold to the graph in the form of an adjustable ‘strength’ slider 701. The slider also controls a depth of the hierarchy that is expended. That is, the graph can be expanded or collapsed via the slider.

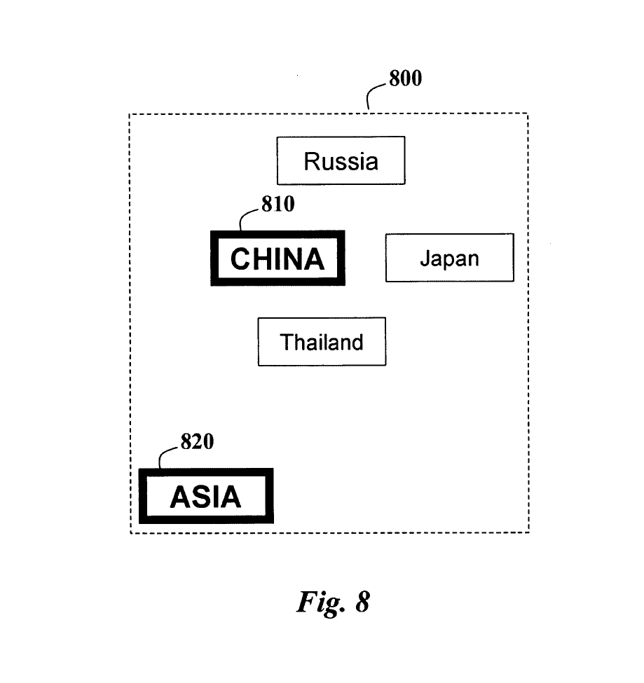

FIG. 8 shows the same result set 200 of a search for “china” however these results are shown on a hierarchical geographical map. The exact match 810 is highlighted and the hierarchy it is located in 820 is highlighted. The hierarchy may be expanded or collapsed automatically when the user's map view is zoomed or under manual control.

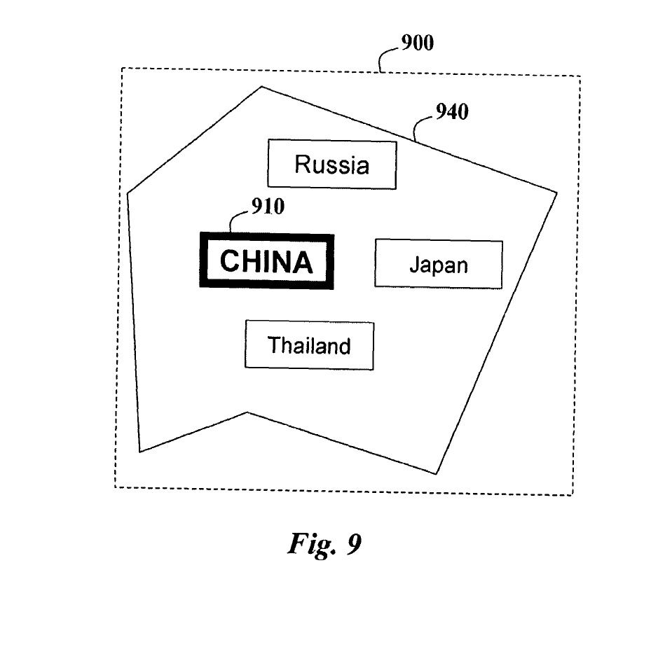

FIG. 9 shows the same result set 200 of a search for “china” however these results are shown on a map with no hierarchy. Additional map data 940 is shown.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A computer-implemented method for rendering a rank-ordered result set for a probabilistic query, comprising the steps of:
acquiring a probabilistic query;
recognizing terms in the probabilistic query;
assigning a probability to each term, the probability expressing a confidence in correctly recognizing the term;
searching a database for items matching the probabilistic query using the terms and the assigned probabilities to produce a result set;
highlighting the items in the result set according to the probabilities; and
outputting the highlighted result set as a hierarchical graph.

2. The method of claim 1, in which the probabilistic query is in a form of an acoustic signal.

3. The method of claim 1, in which the probabilistic query includes speech, and the terms are words.

4. The method of claim 1, in which the highlighting uses visual effects.

5. The method of claim 1, in which the highlighting uses acoustic effects.

6. The method of claim 1, in which the highlighting uses visual and acoustic effects.

7. The method of claim 1, further comprising:
introducing uncertainty into the recognized probabilistic query while searching the database.

8. The method of claim 7, in which the introducing of the uncertainty uses a matching function to change the terms in the recognized probabilistic query.

9. The method of claim 8, in which the matching function iteratively removes selected terms from the probabilistic query and repeats the searching after each removal until the probabilistic query is empty.

10. The method of claim 8, in which the matching function produces an explanation of how the matching is performed while searching is performed.

11. The method of claim 10, in which the highlighting is according to tile explanation.

12. The method of claim 1, in which the hierarchical graph represents a parent-child relationship of the result set as a tree.

13. The method of claim 1, in which the hierarchical graph includes highlighted geographical information.

14. The methods of claim 1, further comprising:
applying an aliasing function to the query before the searching.

15. The method of claim 1, in which the highlighting is inherited according to the hierarchical graph.

16. The method of claim 1, in which selected results in the result are hidden.

17. The method of claim 1, in which the highlighting traverses the hierarchical graph.

18. The method of claim 1, further comprising:
displaying a number of matching results.

19. The method of claim 1, further comprising:
displaying a histogram representing the result set.

20. The method of claim 1, further comprising:
controlling a depth of the hierarchical graph with a slider.

21. A computer-implemented method for rendering a rank-ordered result set for a probabilistic query, comprising the steps of:
acquiring a probabilistic query;
recognizing terms in the probabilistic query;
assigning a probability to each term, the probability expressing a confidence in correctly recognizing the term;
searching a database for items matching the probabilistic query using the terms and the assigned probabilities to produce a result set, while introducing uncertainty into the recognized probabilistic query; and
highlighting the items in the result set according to the probabilities.

22. The method of claim 21, in which the introducing of the uncertainty uses a matching function to change the terms in the recognized probabilistic query.

23. The method of claim 21, in which the matching function produces an explanation of how the matching is performed while searching is performed.

24. The method of claim 21, in which the highlighting is according to the explanation.

25. A computer-implemented method for rendering a rank-ordered result set for a probabilistic query, comprising the steps of:
acquiring a query including terms;
introducing uncertainty into the terms of the query;
assigning a probability to each term, the probability expressing a confidence in correctly recognizing the term;
searching a database for items matching the query using the terms and the assigned probabilities to produce a result set; and
highlighting the items in the result set according to the probabilities.

26. The method of claim 25, further comprising:
outputting the highlighted result set as a hierarchical graph.

27. The method of claim 26, in which the hierarchical graph is a tree.

28. A computer-implemented method for rendering a rank-ordered result set for a probabilistic query matching function, comprising the steps of:
acquiring a query having terms;
initializing a probabilistic query matching function with the terms of the query;
searching a database for items according to the query;
applying the probabilistic query matching function to each item; and
assigning match probabilities to each item according to the probabilistic matching function to produce a result set; and
highlighting the items in the result set according to the probabilities.
